(19) United States
(12) Patent Application Publication
(10) Pub. No.: US 2007/0143121 A1
(43) Pub. Date: Jun. 21, 2007

(54) Method for feature utilization in an electronic device

(76) Inventors: Robert A. Hartman, Cooper City, FL (US); Fernando A. Paz, Lauderdale By The Sea, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/294,737

(22) Filed: Dec. 6, 2005

(51) Int. Cl. G06Q 99/00

(52) U.S. Cl. 705/1

(57) ABSTRACT

A method for feature utilization in an electronic device (102) is disclosed. The method includes determining (302) whether the electronic device is registered for one or more paid services with a network (104). The method further includes controlling (304) access to one or more network service independent features in the electronic device based on whether the electronic device is registered for the one or more paid network services.

### FIELD OF THE INVENTION

This invention relates in general to electronic devices, and more specifically, to feature utilization in the electronic devices.

### BACKGROUND OF THE INVENTION

Electronic devices communicate amongst themselves by using a network, such as a Code Division Multiple Access (CDMA) network, a Global System for Mobile communications (GSM) network, a Universal Mobile Telecommunications Service (UMTS) network, an Integrated Digital Enhanced Network (iDEN), and the like. To enable inbound and outbound communication, an electronic device registers for various paid communication services with the network. Examples of a paid communication service include a dispatch service, an interconnect service, a packet data service, a General Packet Radio Service (GPRS) service, and the like. In addition to communication enabling features, the electronic device may also include features that do not require the paid communication services to operate in full or partially. For example, a feature such as a broadcast FM radio, a music player, a camera, a calculator, a calendar, a phone book, and the like, do not require the paid communication services to operate. These features can be utilized even when the electronic device is not registered for any of the paid communication services with the network.

A network provider, the entity that provides paid communication services, may want to limit or disable the use of network independent features in an electronic device if the electronic device is not registered for one or more paid communication services. There could be a number of reasons for the network provider to do this, including promotion of revenue from the network provider's paid communication services.

### BRIEF DESCRIPTION OF THE FIGURES

The present invention is illustrated by way of example and not limitation in the accompanying figures, in which like references indicate similar elements, and in which:

FIG. 1 represents an environment, where various embodiments of the present invention may be practiced;

FIG. 2 is a block diagram of an electronic device, in accordance with an embodiment of the present invention;

FIG. 3 is a flowchart illustrating a method for feature utilization in an electronic device, in accordance with an embodiment of the present invention; and

FIG. 4 is a flowchart illustrating a method for feature utilization in an electronic device, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements, to help in improving an understanding of embodiments of the present invention.

### DETAILED DESCRIPTION

Before describing in detail embodiments that are in accordance with the present invention, it should be observed that the present invention resides primarily in combinations of method steps and apparatus components related to feature utilization in an electronic device. Accordingly, the apparatus components and method steps have been represented where appropriate by conventional symbols in the drawings, showing only those specific details that are pertinent to understanding the present invention, so as not to obscure the disclosure with details that will be readily apparent to those of ordinary skill in the art, having the benefit of the description herein.

In this document, relational terms such as first and second, and the like may be used solely to distinguish one entity or action from another entity or action without necessarily requiring or implying any actual such relationship or order between such entities or actions. The terms ‘comprises,’ ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

Various embodiments of the present invention provide a method for feature utilization in an electronic device. The method includes determining whether the electronic device is registered for one or more paid services with a network. The method also includes controlling access to one or more features in the electronic device, based on whether the electronic device is registered for the one or more paid services.

Various embodiments of the present invention also provide an electronic device. The electronic device includes a processor. The processor determines whether the electronic device is registered for one or more paid services with a network. The processor is also capable of controlling access to one or more features based on above determination. The electronic device also includes one or more counters operatively coupled to the processor for keeping track of one or more pre-defined parameters.

Throughout this application, the term ‘feature’ or ‘network service independent feature’ is used to denote an application provided by the electronic device that does not rely on require paid communication services to operate in full or partially.

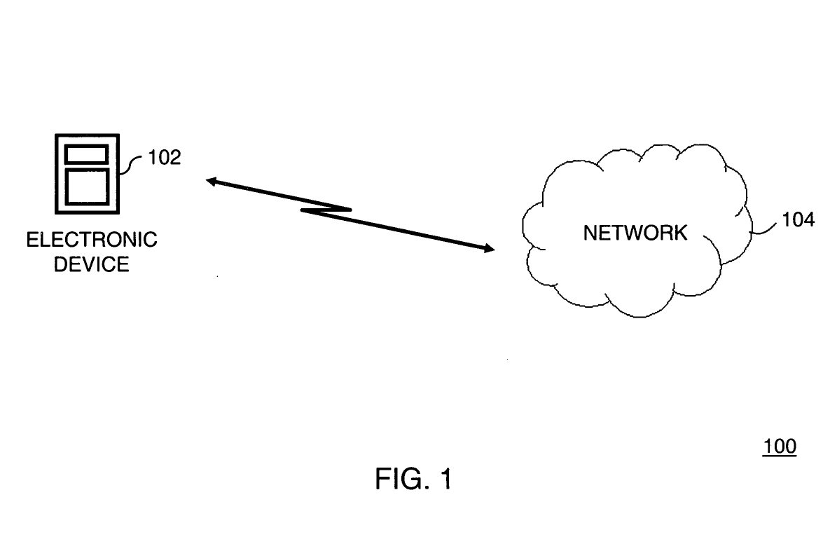

FIG. 1 represents an environment 100, where various embodiments of the present invention may be practiced. The environment 100 includes an electronic device 102 and a network 104. Examples of the electronic device 102 include a mobile phone, a Personal Digital Assistant (PDA), a PDA integrated with a phone, a satellite phone, and the like. Though the environment 100 is shown to include only the electronic device 102, however, the environment 100 may include a plurality of electronic devices. The electronic device 102 communicates with other electronic devices through the network 104. Examples of the network 104 include a CDMA network, a GSM network, a UMTS network, and an iDEN network.

The electronic device 102 may include, in addition to conventional features required for enabling communication, additional features such as a radio, a music player, a camera, a calculator, a calendar, a phone book, and the like that do not require any paid service to operate in full or partially. The electronic device 102 may register for paid services with the network 104. Examples of a paid service include a dispatch service, an interconnect service, a packet data service such as GPRS, and the like.

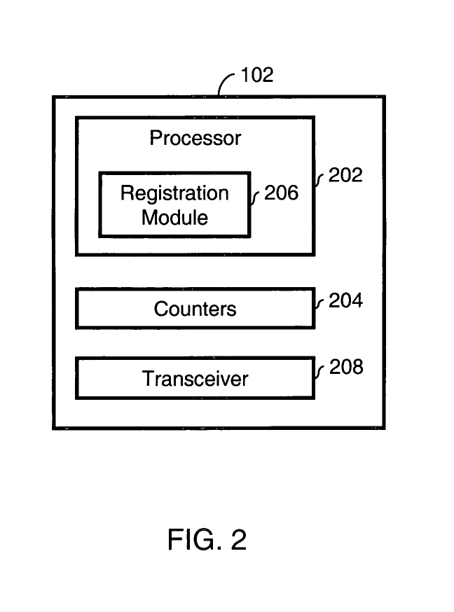

FIG. 2 is a block diagram of the electronic device 102, in accordance with an embodiment of the present invention. The electronic device 102 includes a processor 202 and a counter 204. The processor 202 controls access to one or more features in the electronic device 102. The one or more features do not require one or more paid services to operate. The access to the one or more features is controlled based on whether the electronic device 102 is registered for one or more paid services. In an embodiment of the present invention, the processor 202 also includes a registration module 206 that determines whether the electronic device 102 is registered for the one or more paid services.

The counter 204 is operatively coupled to the processor 202. The counter 204 keeps track of one or more pre-defined parameters. Though the electronic device 102 is shown to include only the counter 204, however, the electronic device 102 may include a plurality of counters. In an embodiment of the present invention, there can be one counter for each feature in the electronic device 102. The access to the one or more features is also controlled, based on the one or more pre-defined parameters. Examples of the pre-defined parameters include the number of attempts made to register for the one or more paid services, the number of times one or more features have been accessed since a registration failure, the number of days the one or more features have been accessed since the registration failure, and time for which the one or more features have been accessed since the registration failure. The electronic device 102 further includes a transceiver 208. The transceiver 208 is configured to send registration requests for the one or more paid services to the network 104. Further, the transceiver 208 also receives replies in response to the registration requests from the network 104.

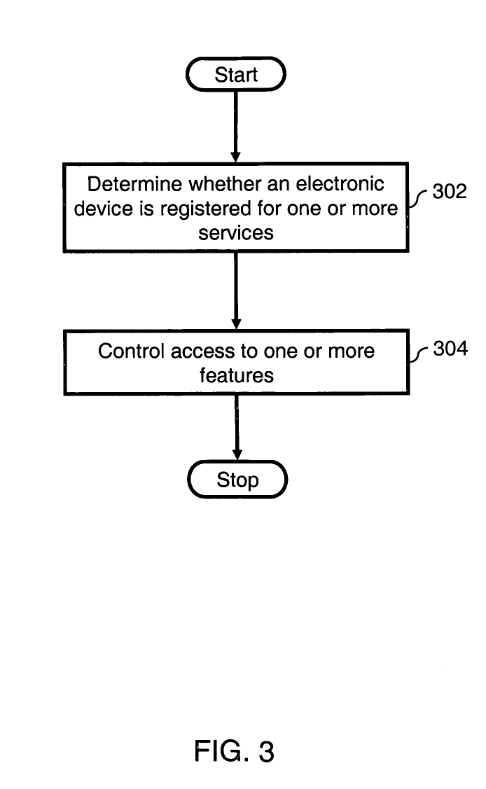

FIG. 3 is a flowchart illustrating a method for feature utilization in an electronic device, in accordance with an embodiment of the present invention. At step 302, it is determined whether the electronic device is registered for one or more paid services with a network. The electronic device may register for the one or more paid services by sending a registration request to the network. Thereafter, the network may send a reply in response to the registration request, to confirm whether the electronic device is registered. At step 304, the access to one or more features in the electronic device is controlled. The one or more features are network independent features that do not require the one or more paid services to operate. The access to the one or more features is controlled based on whether the electronic device is registered for the one or more paid services. For example, when a user has not made a payment for a paid service, such as a dispatch service, then the user may get deregistered for that service. Therefore, access to the features in the electronic device may be restricted. In an embodiment of the present invention, when no reply is received from the network in response to the registration, indicating that the electronic device has moved out of coverage area of the network, access to the one or more features may be blocked or at least partially restricted.

In an embodiment of the present invention, when an electronic device is not registered for one or more paid services, it is determined whether one or more pre-defined parameters exceed one or more threshold values. Access to one or more features in an electronic device is at least partially allowed when the one or more pre-defined parameters do not exceed the one or more threshold values. For example, when access to a camera is partially restricted, then the camera can be used only for a specific number of times till an electronic device registers again for the paid service with the network. Examples of the one or more pre-defined parameters include, but are not limited to, the number of attempts to register for one or more paid services, the number of times one or more features have been accessed since a registration failure, the number of days the one or more features have been accessed since the registration failure and the time for which the one or more features have been accessed since the registration failure. Examples of a threshold value include, but are not limited to, a pre-defined attempt limit, a pre-defined access limit, a pre-defined day limit, and a pre-defined time limit. When the one or more pre-defined parameters exceed the one or more threshold values, then access to the one or more features is at least partially restricted. For example, when access to a music player is partially restricted, then a user can be allowed to use the music player continuously only for 10 minutes. After 10 minutes, the music player can stop automatically.

In an embodiment of the present invention, a pre-defined parameter is the number of attempts the electronic device has made to register for the one or more paid services. When the number of attempts exceeds a pre-defined attempt limit, then access to one or more features is at least partially restricted. When a user has not made payment for a paid service, such as a dispatch service, then the user is not registered for that service. Therefore, access to the features, such as a calculator feature, in the electronic device may be restricted when the last date for making the payment has passed.

In an embodiment of the present invention, the pre-defined parameter is the number of times one or more features have been accessed since the failure to register for one or more paid services. When the number of times exceeds a pre-defined access limit, then access to one or more features is at least partially restricted. For example, a failure can occur because payment has not been made for utilizing a paid service. Therefore, access to a camera feature in an electronic device may be restricted, such that the camera can be used for only 20 times until the electronic device is registered again for the paid service.

In another embodiment of the present invention, a pre-defined parameter is the number of days for which one or more features have been accessed since a failure to register for one or more paid services. When the number of days exceeds a pre-defined day limit, then the access to the one or more features is at least partially restricted. For example, the access to the camera feature in an electronic device may be restricted, such that the camera can be accessed for only for 20 days until the electronic device is registered again for a paid service.

In yet another embodiment of the present invention, a pre-defined parameter is time for which one or more features have been accessed since a failure to register for one or more paid services. When the time exceeds a pre-defined time limit, then access to the one or more features is at least partially restricted. For example, access to a music player in an electronic device is restricted, such that the music player can be accessed for only for 20 hours until the electronic device is registered again.

In an embodiment of the present invention, one or more reasons for restricting access to one or more features are displayed. For example, a reason, such as non-payment for a interconnect service, may be displayed for inaccessibility of the camera. In another example, due a failure of registration for an interconnect service, it can be displayed that the access to a music player is allowed for 15 hours only. Further, the access to the one or more features is granted when the electronic device 102 again registers itself for the paid service.

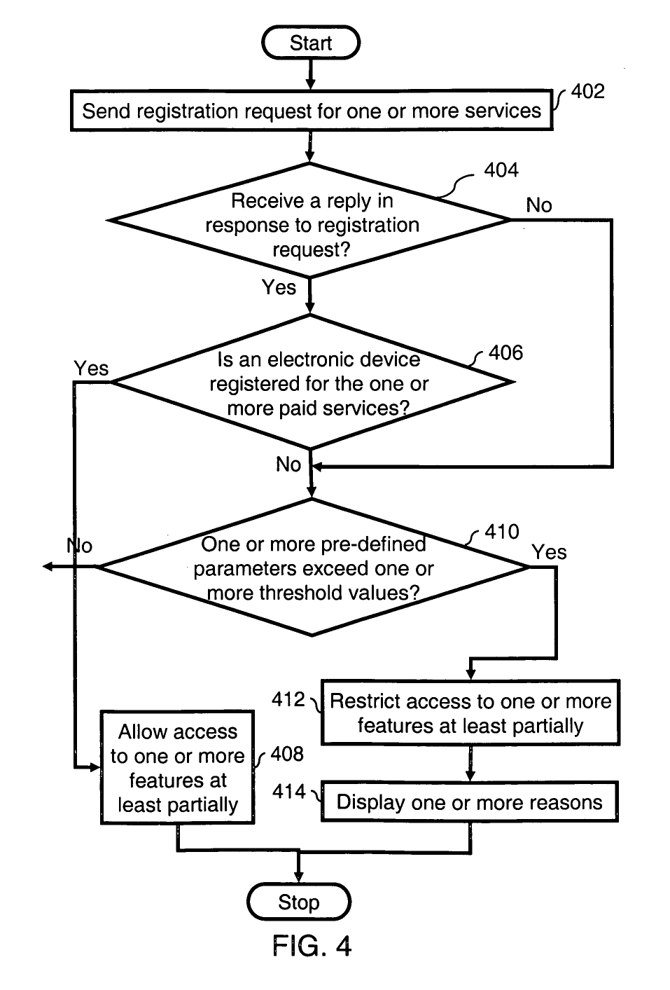

FIG. 4 is a flowchart illustrating a method for feature utilization in the electronic device 102, in accordance with another embodiment of the present invention. To describe the method, reference will be made to FIG. 1 and FIG. 2, although it is understood that the method can be implemented with reference to any other embodiment of the present invention. In addition, the method can contain a greater or a fewer number of steps than shown in FIG. 4. At step 402, a registration request for one or more paid services is sent to the network 104. The registration request is sent to verify whether the electronic device 102 is registered for the one or more paid services with the network 104. In an embodiment of the present invention, the transceiver 208 of the electronic device checked whether a reply to the registration request is received from the network 104. In an embodiment of the 102 sends the registration request to the network 104. At step 404, it is present invention, the processor 202 checks whether a reply to the registration request is received by the transceiver 208.

When the electronic device 102 receives the reply, step 406 is performed. At step 406, it is determined whether the electronic device 102 is registered for the one or more paid services with the network 104. In an embodiment of the present invention, the registration module 206 determines whether the electronic device 102 is registered for the one or more paid services with the network 104. For example, a user utilizes a dispatch service provided by the network 104. Then the registration module 206 verifies with the network 104, whether the user is registered for the dispatch service. Thereafter, at step 408, when the electronic device 102 is registered for the one or more paid services, access to one or more features is at least partially allowed. In an embodiment of the present invention, the processor 202 allows the access to the one or more features. For example, a user is registered for a dispatch service with the network 104. Thus, the user may be allowed to access features, such as a camera, a music player, and the like, of the electronic device 102.

When the electronic device 102 is not registered for the one or more paid services, or when the electronic device 102 does not receive a reply from the network 104 indicating that the electronic device 102 has moved out of coverage area of the network 104 then step 410 is performed. At step 410, it is determined whether one or more pre-defined parameters exceed one or more threshold values. In an embodiment of the present invention, the counter 204 determines whether the one or more pre-defined parameters exceed the one or more threshold values. At step 408, when the one or more pre-defined parameters do not exceed the one or more threshold values, access to the one or more features is at least partially allowed. In an embodiment of the present invention, the processor 202 allows at least partial access to the one or more features. At step 412, when the one or more pre-defined parameters exceed the one or more threshold values, access to the one or more features is at least partially restricted. In an embodiment of the present invention, the processor 202 at least partially restricts access to the one or more features. Thereafter, at step 414, one or more reasons for restricting the access to the one or more features are displayed. In another embodiment of the present invention, a registration status for one or more paid services displayed. The registration status for the one or more paid services includes a list of paid services that are registered with the network 104. In an embodiment of the present invention, access to the one or more features is again granted when the electronic device 102 registers itself again for the one or more paid services.

For example, when a user has not made a payment for utilizing a dispatch service, a registration of the electronic device 102 for the dispatch service may be cancelled. The user can be given a threshold period of 10 days to make the payment. The processor 202 allows the user to access one or more features of the electronic device 102 for 10 days. Thereafter, the processor 202 may restrict access to the one or more features when the electronic device 102 is not registered till the tenth day. When the user makes the payment, the electronic device 102 is again registered for the dispatch service. Thereafter, the processor 202 grants the access to the one or more features.

Various embodiments of the present invention, as described above, restrict a user from utilizing various features provided in an electronic device when registration of the electronic device for one or more paid services is cancelled. Further, various embodiments of the present invention enable the user to view registration status for various paid services and also view reasons for restriction of the features.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for feature utilization in an electronic device, the method comprising:
determining whether the electronic device is registered for one or more paid services with a network; and
controlling access to one or more features in the electronic device based on whether the electronic device is registered for the one or more paid services, wherein the one or more features do not require the one or more paid services to operate.

2. A method for feature utilization in an electronic device as defined in claim 1, wherein the method further comprises:
sending a registration request for the one or more paid services to the network; and
receiving a reply in response to the registration request from the network.

3. A method for feature utilization in an electronic device as defined in claim 2 further comprising restricting access to the one or more features at least partially when no reply is received from the network in response to the registration request.

4. A method for feature utilization in an electronic device as defined in claim 1, wherein controlling access to the one or more features comprises allowing access to the one or more features at least partially when the electronic device is registered for the one or more paid services.

5. A method for feature utilization in an electronic device as defined in claim 1, wherein the method further comprises determining whether one or more pre-defined parameters exceed one or more threshold values when the electronic device is not registered for the one or more paid services.

6. A method for feature utilization in an electronic device as defined in claim 5, wherein controlling access to one or more features in the electronic device comprises restricting access to the one or more features at least partially when the one or more pre-defined parameters exceed the one or more threshold values.

7. A method for feature utilization in an electronic device as defined in claim 6, wherein the method further comprises displaying one or more reasons for restricting the access to the one or more features at least partially.

8. A method for feature utilization in an electronic device as defined in claim 6, wherein the method further comprises granting access to the one or more features at least partially when the electronic device registers.

9. A method for feature utilization in an electronic device as defined in claim 5, wherein controlling access to one or more features in the electronic device comprises allowing access to the one or more features at least partially when the one or more pre-defined parameters do not exceed the one or more threshold values.

10. A method for feature utilization in an electronic device as defined in claim 5, wherein the one or more pre-defined parameters are selected from a group comprising number of attempts to register for the one or more paid services, number of times the one or more features have been accessed since a registration failure, number of days the one or more features have been accessed since the registration failure, and time for which the one or more features have been accessed since the registration failure.

11. A method for feature utilization in an electronic device as defined in claim 5, wherein the one or more threshold values are selected from a group comprising a pre-defined attempt limit, a pre-defined access limit, a pre-defined day limit and a pre-defined time limit.

12. A method for feature utilization in an electronic device, the method comprising:
determining whether the electronic device is registered for one or more paid services with a network;
allowing access to one or more features at least partially when the electronic device is registered for the one or more paid services, wherein the one or more features do not require the one or more paid services to operate;
determining whether one or more pre-defined parameters exceed one or more threshold values when the electronic device is not registered for the one or more paid services; and
restricting access to the one or more features at least partially when the one or more pre-defined parameters exceed the one ore more threshold values.

13. A method for feature utilization in an electronic device as defined in claim 12, wherein the method further comprises:
sending a registration request for the one or more paid services to the network; and
receiving a reply in response to the registration request from the network.

14. A method for feature utilization in an electronic device as defined in claim 12, wherein the method further comprises allowing access to the one or more features at least partially when the one or more pre-defined parameters do not exceed the one or more threshold values.

15. A method for feature utilization in an electronic device as defined in claim 12, wherein the method further comprises granting access to the one or more features at least partially when the electronic device registers.

16. A method for feature utilization in an electronic device as defined in claim 12, wherein the method further comprises displaying one or more reasons for restricting access to the one or more features at least partially.

17. A method for feature utilization in an electronic device as defined in claim 12, wherein the method further comprises allowing access to the one or more features at least partially when the electronic device is registered for the one or more paid services.

18. A method for feature utilization in an electronic device as defined in claim 12, wherein the one or more pre-defined parameters are selected from a group comprising number of attempts to register for the one or more paid services, number of times the one or more features have been accessed since a registration failure, number of days the one or more features have been accessed since the registration failure, and time for which the one or more features have been accessed since the registration failure.

19. A method for feature utilization in an electronic device as defined in claim 12, wherein the one or more threshold values are selected from a group comprising a pre-defined attempt limit, a pre-defined access limit, a pre-defined day limit and a pre-defined time limit.

20. An electronic device comprising:
a processor, the processor capable of controlling access to one or more features in the electronic device based on whether the electronic device is registered for one or more paid services with a network; and
one or more counters operatively coupled to the processor, the one or more counters keeping track of one or more pre-defined parameters.

21. An electronic device as defined in claim 20, wherein the electronic device further comprises a transceiver, the transceiver configured to send registration requests for the one or more paid services to the network and to receive replies from the network, in response to the registration requests.

22. An electronic device as defined in claim 20, wherein the processor comprises a registration module for determining whether the electronic device is registered for the one or more paid services with the network.

23. An electronic device as defined in claim 20, wherein the one or more paid services are selected from a group comprising a dispatch service, an interconnect service and a packet data service.
